(19) United States
(12) Patent Application Publication
(10) Pub. No.: US 2011/0050393 A1
(43) Pub. Date: Mar. 3, 2011

(54) PORTABLE WIRELESS FINGERPRINTER INDENTIFICATION SYSTEM AND METHOD

(76) Inventor: SeongWook Kang, Seoul (KR)

(21) Appl. No.: 12/812,875

(22) PCT Filed: Dec. 30, 2008
(86) PCT No.: PCT/KR08/07774

§ 371 Date: Jul. 14, 2010

(30) Foreign Application Priority Data
Jan. 18, 2008 (KR) 10-2008-0005558

(51) Int. Cl. G06F 7/04

(52) U.S. Cl. 340/5.53

(57) ABSTRACT

The present invention relates to a portable wireless fingerprinter identification system, in which user's four-digit identification number is transmitted to a main system by using a portable terminal having a fingerprint recognition element and a keypad via electric frequencies such as radio frequencies or Bluetooth, or light such as infrared rays, and user's fingerprint registered in a database of the main system is transmitted to the portable terminal via electric frequencies such as radio frequencies or Bluetooth, or light such as infrared rays, so that the received user's fingerprint is recognized and verified by a fingerprint recognition sensor of the portable terminal for the direct control of the main system by the portable terminal, and a method for the wireless fingerprint recognition.

### TECHNICAL FIELD

The present invention relates to a portable wireless fingerprint recognition system, in which user's four-digit identification number is transmitted to a main system by using a portable terminal having a fingerprint recognition element and a keypad via electric waves such as radio frequencies or Bluetooth (short-distance wireless communications standard), or light such as infrared rays, and user's fingerprint registered in a database of the main system is transmitted to the portable terminal via electric waves such as radio frequencies or Bluetooth, or light such as infrared rays, so that the received user's fingerprint is recognized and verified by the fingerprint recognition part of the portable terminal, resulting in the direct control of the main system by the portable terminal, and a method for the wireless fingerprint recognition.

### BACKGROUND ART

In general, a portable terminal using fingerprints may be used in every security system in which fingerprints are required. Therefore, a user carries only one terminal and uses the same in various different security systems. Also, such security systems in which fingerprints are required may be directly and simultaneously controlled by a plurality of users by means of their portable terminals each having the fingerprint recognition element.

Previously, the fingerprint recognition system is connected to the main system by wire, so that users should directly and inconveniently touch a fingerprint recognition part of the main system with their fingers all the time. Further, even though a plurality of users have to carry out the fingerprint recognition simultaneously, they should carry out the fingerprint recognition in turn, which is annoying time-consuming procedure, so that they cannot pass a security section simultaneously.

Furthermore, there is limitation in the fingerprint recognition if the fingerprint recognition part is located at a polluted place or at a difficult place for users direct touch.

### DISCLOSURE OF INVENTION

### Technical Problem

The present invention is derived to resolve the above and any other problems of the prior art and has an object to provide a portable wireless fingerprint recognition system, in which user's four-digit identification number is transmitted to a main system by using a portable terminal having a fingerprint recognition element and a keypad via electric waves such as radio frequencies or Bluetooth, or light such as infrared rays, instead of touching a fingerprint recognition part of a main system with a finger, and user's fingerprint registered in a database of the main system is transmitted to the portable terminal via electric frequencies such as radio frequencies or Bluetooth, or light such as infrared rays, so that the received user's fingerprint is recognized and verified by the fingerprint recognition part of the portable terminal, resulting in the direct control of the main system by the portable terminal.

The present invention has another object to provide a method for the wireless fingerprint recognition.

The portable wireless fingerprint recognition system may be adopted in various security systems if users carry a portable terminals personally, in particular, in security sections require perfect security systems such as laboratories, apartment buildings, or even engine starting systems of vehicles.

### Technical Solution

According to the present invention, the portable wireless fingerprint recognition system may directly verify user's fingerprint received from a main system by means of a portable terminal even at a remote place, so that the main system may be controlled by the portable terminal. Therefore, user may use a wire-connected fingerprint recognition part of a main system even without direct fingerprint touch.

### ADVANTAGEOUS EFFECTS

According to the present invention, the portable wireless fingerprint recognition system may be adopted in every security system of which users carry portable terminals each having a fingerprint recognition element and a key pad, and the main system may be used even in a place that the fingerprint recognition part is located at a polluted place or at a difficult place for direct touch.

### BRIEF DESCRIPTION OF DRAWINGS

Further features and details of the invention will be apparent from the following description of certain specific embodiments which is given by way of example only with reference to the accompanying drawings, in which:

FIG. 1 is a schematic view showing the entire structure of a portable wireless fingerprint recognition system according to a preferred embodiment of the present invention;

FIG. 2 is a plane view showing a security system according to a preferred embodiment of the present invention;

FIG. 3 is a view showing an exterior structure of a portable terminal according to a preferred embodiment of the present invention; and

FIG. 4 is a flowchart for explaining a main verification system according to the present invention.

### MODE FOR THE INVENTION

Hereafter, an embodiment of a portable wireless fingerprint recognition system which carries out the present invention will be described with reference to the drawings.

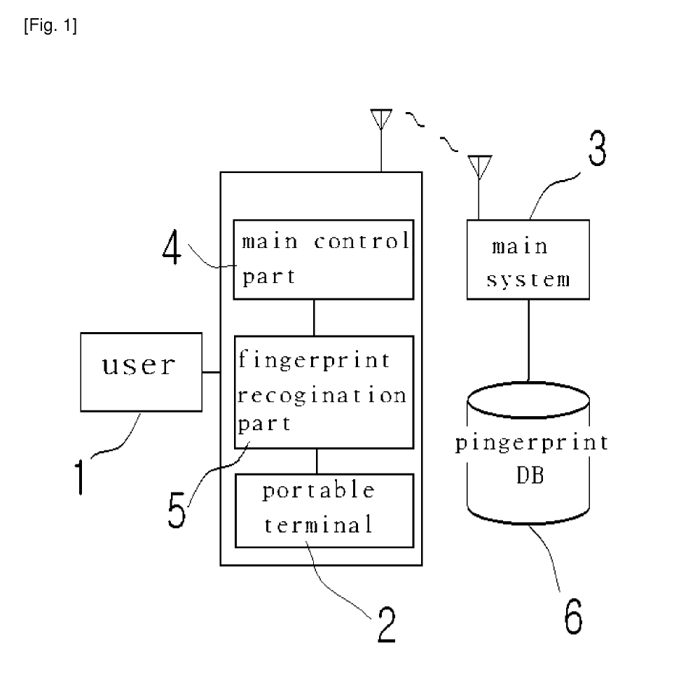

FIG. 1 is a schematic view showing the entire structure of a portable wireless fingerprint recognition system according to a preferred embodiment of the present invention. Referring to FIG. 1, the portable wireless fingerprint recognition system according to a preferred embodiment of the present invention includes a portable terminal 2 having a main control part 4 which carries out a series of operation according to a key input of a user 1 and a fingerprint recognition part 5, and a main system 3 which receives a radio signal from the portable terminal 2, searches fingerprint data of the user from a fingerprint database 6, and transmits the searched fingerprint data to the portable terminal 2, wherein the main system 3 is driven to operate as verification is carried out according to a radio signal that the fingerprint data verifies the user's identification in the portable terminal 2.

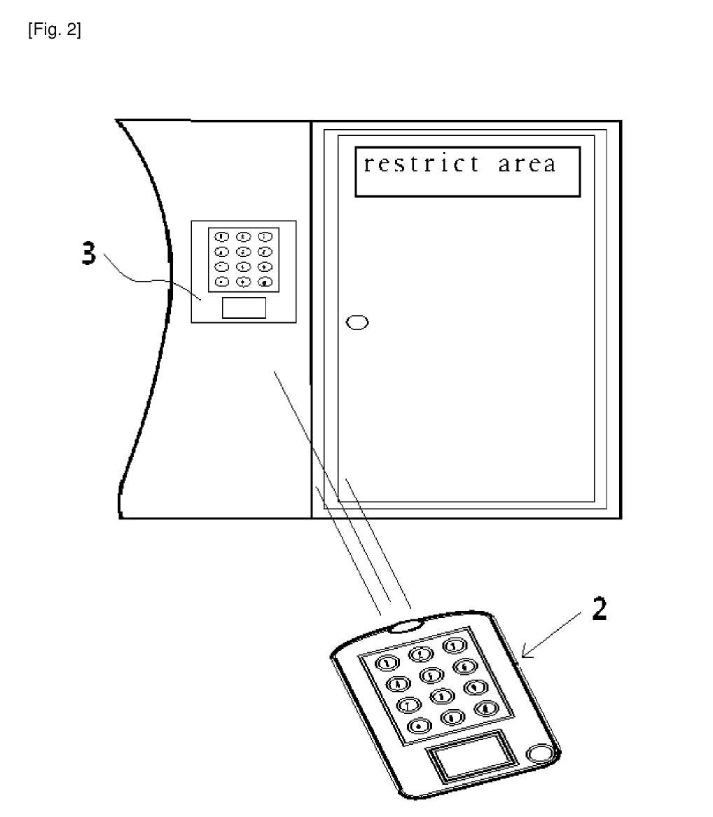

FIG. 2 is a view showing a state that a security system is driven to operate by the portable wireless fingerprint recognition system of the present invention, which shows the portable terminal 2 carried and manipulated by the user 1 and the main system 3 mounted to a door of a security area to be driven by the manipulation of the portable terminal 2 so as to carry out verification.

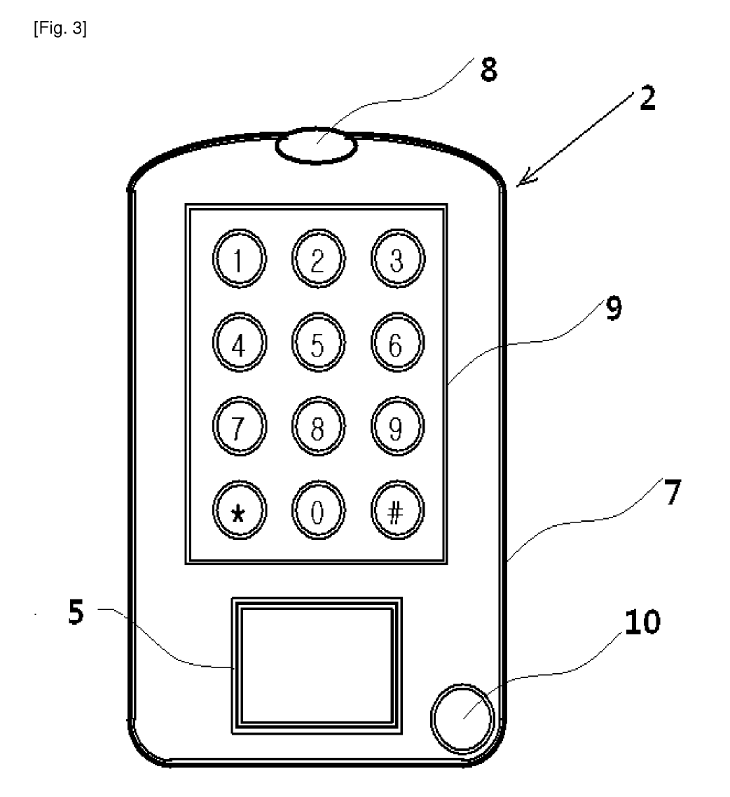

FIG. 3 is view showing an exterior structure of the portable terminal 2 according to the present invention. Referring to FIG. 3, the portable terminal 2 includes an LED lamp 8 to blink when a signal is sent to the main system 3 from a main body 7 of the portable terminal or a signal is received from the main system 3, a keypad 9 displaying numerals from 0 to 9 and symbols of ‘*’ and ‘#’, and a fingerprint recognition part 5 for recognizing and verifying a fingerprint received from the main system 3. Reference symbol 10 which is not explained is a hole for inserting a key and the like.

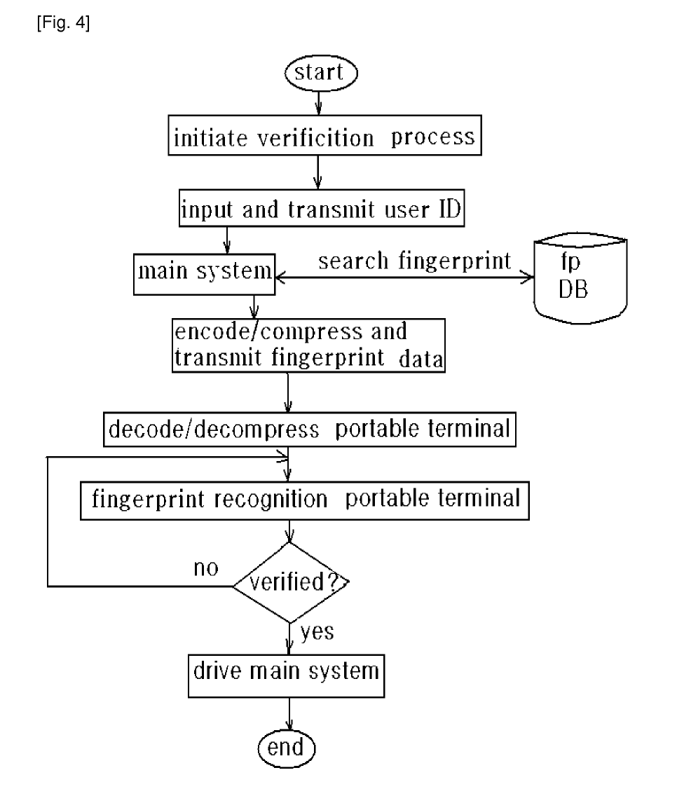

FIG. 4 is a flowchart for explaining a main verification system according to the present invention

Now, the operation of the portable wireless fingerprint recognition system according to the present invention will be described in more detail.

The verification system of the portable terminal 2 and the main system 3 is initiated when the user 1 presses a key *’ of the keypad 9 on the portable terminal 2 in a certain security section, wherein user's identification number is transmitted to the main system 3 as the user presses pre-registered four-digit identification number of his own and a key ‘#’ in sequence.

At this time, the transmitting and receiving of data between the portable terminal 2 and the main system 3 are carried out by electric waves such as radio frequencies or Bluetooth, or light such as infrared rays.

The main system 3, which receives the identification number of the user 1, searches fingerprint data registered in the fingerprint database 6 and transmits the user's fingerprint data to the portable terminal 2 of the user 1 after encoding and compressing the searched user's fingerprint data.

Also, the transmitting and receiving of data between the portable terminal 2 and the main system 3 are carried out by electric waves such as radio frequencies or Bluetooth, or light such as infrared rays.

The portable terminal 2 decodes and decompresses the fingerprint data received from the portable terminal 2 to prepare the main control part 4 in a standby state, and the fingerprint recognition part 5 transmits a recognized fingerprint to the main control part 4 as the user 1 touches the fingerprint recognition part 5 with a finger for fingerprint recognition, so that the main control part 4 kept in the standby state compares the fingerprint received from the main system 3 with the recognized fingerprint.

If the user is verified as a result of the fingerprint comparison, a radio signal is transmitted from the portable terminal 2 to the main system 3 automatically under the control of the main control part 4, so that the verification system of the main system 3 is driven to operate.

If an error message is generated three times or more in the process of user verification, if a verification setting section is deviated, or if time elapses more than one minutes, the verification procedure may be re-started from a system initiating step or from a user identification registering step.

According to the present invention, the portable terminal 2 and the main system 3 constitute a single wireless fingerprint recognition system, so that a user may simply carry out the verification of the main system 3 wirelessly at a remote place by using the portable terminal 2 without approaching the main system 3 for driving the verification system.

### INDUSTRIAL APPLICABILITY

According to the present invention, a plurality of users may pass a gateway security system simultaneously by carrying out fingerprint recognition at remote places by means of the portable terminals instead of directly touching the fingerprint recognition part of a main security system with their fingers. Further, such fingerprint recognition may be conveniently carried out at any places where the security system is required by simply carrying their portable terminals, thereby increasing the security effect. Furthermore, user's fingerprint registered in the main system may be verified not by the main system but by the portable terminal directly, so that the main security system may be under control of the portable terminal.

It should further be apparent to those skilled in the art that various changes in form and detail of the invention as shown and described above may be made.

It is intended that such changes be included within the spirit and scope of the claims appended hereto.

### Sequence Listing

security, fingerprint, recognition, terminals, wireless

1. A portable wireless fingerprinter indentification system, comprising:
a portable terminal having an LED lamp mounted in a main body for blinking when transmitting a signal to a main system or receiving a signal from the main system, a keypad representing numbers from 0 to 9 and symbols of ‘*’ and ‘#’, a fingerprint recognizing part for recognizing and verifying a fingerprint received from the main system, and a main control part for controlling the above parts; and
the main system mounted in a restricted area for receiving radio signals by electric waves or light transmitted from the portable terminal and searching fingerprint data from a fingerprint database to transmit the searched fingerprint data to the portable terminal, and driven to operate according to verification carried out when a radio signal for verifying identification is transmitted from the portable terminal.

2. A method for wireless fingerprint indentification for a mobile cell comprising the steps of:
initiating a verification system for a main system and a portable terminal according to an input of a key ‘*’ of a key pad of mobile cell;
pressing user pre-registered four-digit identification number via the keypad of the portable terminal and wirelessly transmitting the user's identification number by pressing a key ‘#’;
searching a fingerprint data registered in a fingerprint database of a main system as the main system receives the user's identification number from the portable terminal and encoding and compressing searched user's fingerprint to transmit the same to user's portable terminal wirelessly;
carrying out decoding and decompressing of the received fingerprint in the portable terminal and preparing a main control part in a standby state; and
wirelessly transmitting a verification signal automatically to a main system under the control of the main control part if user's identification number is verified by touching a fingerprint recognition part of the portable terminal with a finger.
